(19) United States
(12) Patent Application Publication
(10) Pub. No.: US 2012/0124241 A1
(43) Pub. Date: May 17, 2012

(54) Systems and Methods for Sync Mark Detection

(75) Inventors: Shaohua Yang, San Jose, CA (US); Dahua Qin, Allentown, PA (US)

(73) Assignee: LSI Corporation

(21) Appl. No.: 12/946,048

(22) Filed: Nov. 15, 2010

(51) Int. Cl. G06F 15/16

(52) U.S. Cl. 709/248

(57) ABSTRACT

Various embodiments of the present invention provide systems and methods for data processing. As an example, a circuit for data processing is described that includes a sync mark pattern match calculation circuit and an indication circuit. The sync mark pattern match calculation circuit is operable to provide at least a first comparison value corresponding to a comparison between a received input data set and a sync mark pattern, and a second comparison value corresponding to a comparison between the received input data set and a subset of the sync mark pattern and a subset of a preamble pattern. The indication circuit is operable to compare the first comparison value with the second comparison value, and to assert a sync found signal based at least in part on the comparison of the first comparison value and the second comparison value.

### BACKGROUND OF THE INVENTION

The present inventions are related to systems and methods for data processing, and more particularly to systems and methods for detecting patterns in a data stream.

Various circuits have been developed that provide for identifying synchronization marks within a data stream. As an example, a synchronization mark is identified based upon a threshold comparison. Such a threshold comparison approach depends highly upon determining an appropriate threshold for comparison. Where the selected threshold is too high, sync marks will be missed. Alternatively, where the selected threshold is too low, sync marks may be incorrectly identified. Either case is problematic for proper data processing.

Hence, for at least the aforementioned reasons, there exists a need in the art for advanced systems and methods for sync mark identification.

### BRIEF SUMMARY OF THE INVENTION

The present inventions are related to systems and methods for data processing, and more particularly to systems and methods for detecting patterns in a data stream.

Various embodiments of the present invention provide data processing circuits that include a sync mark pattern match calculation circuit and an indication circuit. The sync mark pattern match calculation circuit is operable to provide at least a first comparison value corresponding to a comparison between a received input data set and a sync mark pattern, and a second comparison value corresponding to a comparison between the received input data set and a subset of the sync mark pattern and a subset of a preamble pattern. The indication circuit is operable to compare the first comparison value with the second comparison value, and to assert a sync found signal based at least in part on the comparison of the first comparison value and the second comparison value. In some cases, the circuit is implemented as part of an integrated circuit. In various cases, the circuit is implemented as part of either a storage device or a wireless communication device.

In some instances of the aforementioned embodiments, the comparison between the received input data set and the sync mark pattern includes calculating a first Euclidean distance between the received input data set and the sync mark pattern, and the comparison between the received input data set and the received input data set and a subset of the sync mark pattern and a subset of a preamble pattern includes calculating a second Euclidean distance between the received input data set and the received input data set and a subset of the sync mark pattern and a subset of a preamble pattern. In such instances, the first comparison value is the first Euclidean distance and the second comparison value is the second Euclidean distance.

In one or more instances of the aforementioned embodiments, the sync mark pattern is M bits in length, the subset of the sync mark pattern is N bits in length, and the subset of the preamble pattern is M-N bits in length. In some such instances, the value of M is twenty, and the value of N may be one of four, eight, twelve and sixteen. In other such instances, the sync mark pattern match calculation circuit is operable to process Y bits at a time. In such instances, the subset of the sync mark pattern may be one of the 4Y most significant bits of the sync mark pattern, the 3Y most significant bits of the sync mark pattern, the 2Y most significant bits of the sync mark pattern, or the Y most significant bits of the sync mark pattern. In other such cases, the value of M is twenty, and the subset of the sync mark pattern may be one of the sixteen most significant bits of the sync mark pattern, the twelve most significant bits of the sync mark pattern, the eight most significant bits of the sync mark pattern, or the four most significant bits of the sync mark pattern. In various instances of the aforementioned embodiments, the subset of the preamble pattern is a repeating portion of the preamble pattern.

In some instances of the aforementioned embodiments, the sync mark pattern is twenty bits in length, the subset of the sync mark pattern is a first subset of the sync mark pattern, the subset of the preamble pattern is a first subset of the preamble pattern, and the sync mark pattern match calculation circuit is further operable to: provide a third comparison value corresponding to a comparison between the received input data set and a third subset of the sync mark pattern and a third subset of a preamble pattern; provide a third comparison value corresponding to a comparison between the received input data set and a third subset of the sync mark pattern and a third subset of a preamble pattern; provide a fourth comparison value corresponding to a comparison between the received input data set and a fourth subset of the sync mark pattern and a fourth subset of a preamble pattern; and provide a fifth comparison value corresponding to a comparison between the received input data set and a fifth subset of the sync mark pattern and a fifth subset of a preamble pattern. In such instances, the indication circuit is further operable to compare the first comparison value with the second comparison value, the third comparison value, the fourth comparison value and the fifth comparison value, and to assert the sync found signal based at least in part on the comparison of the first comparison value, the second comparison value, the third comparison value, the fourth comparison value and the fifth comparison value. In some such instances, the first subset of the preamble pattern, the second subset of the preamble pattern, the third subset of the preamble pattern, the fourth subset of the preamble pattern, and the fifth subset of the preamble pattern are the same.

Other embodiments of the present invention provide methods for detecting a data pattern. The methods include: receiving an input data set; comparing the input data set with a first portion of a sync mark pattern to yield a first comparison value; comparing the input data set with a second portion of the sync mark pattern to yield a second comparison value; comparing the input data set with a preamble pattern to yield a third comparison value; summing at least the first comparison value and the second comparison value to yield a first result; summing at least the second comparison value and the third comparison value to yield a second result; and asserting a sync found signal base upon the first result relative to the second result.

In some instances of the aforementioned embodiments, the sync found signal indicates that a sync mark was found when at least the first result is less than the second result. In one or more instances of the aforementioned embodiments, the first portion of the sync mark pattern includes the most significant bits of the sync mark pattern, and the second portion of the sync mark pattern includes the least significant bits of the sync mark pattern. As used herein, the phrase “least significant bits” is used in its broadest sense to refer the right hand bits of a pattern when the pattern is represented in periods extending from left to right. Similarly, the phrase “most significant bits” is used in its broadest sense to refer the left hand bits of a pattern when the pattern is represented in periods extending from left to right. In one or more instances of the aforementioned embodiments, the preamble pattern is a repeating portion of a larger pattern.

Yet other embodiments of the present invention provide storage device that include a storage medium maintaining a representation of an input data set; an analog front end circuit operable to sense the representation of the input data set and to provide the input data set as an output; and a data processing circuit. The data processing circuit includes a sync mark pattern match calculation circuit and an indication circuit. The sync mark pattern match calculation circuit is operable to provide at least a first comparison value corresponding to a comparison between a received input data set and a sync mark pattern, and a second comparison value corresponding to a comparison between the received input data set and a subset of the sync mark pattern and a subset of a preamble pattern. The indication circuit is operable to compare the first comparison value with the second comparison value, and to assert a sync found signal based at least in part on the comparison of the first comparison value and the second comparison value.

This summary provides only a general outline of some embodiments of the invention. Many other objects, features, advantages and other embodiments of the invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a known magnetic storage medium and sector data scheme;

FIG. 2a depicts a non-threshold based sync mark detector circuit in accordance with one or more embodiments of the present invention;

FIG. 2b graphically shows comparisons yielding the various outputs of a sync mark pattern match calculation circuit included in the non-threshold based sync mark detector circuit of FIG. 2a;

FIG. 3 depicts a sync mark pattern match calculation circuit in accordance with various embodiments of the present invention;

FIG. 4 shows another sync mark pattern match calculation circuit in accordance with some embodiments of the present invention;

FIGS. 5a-5b show a method in accordance with one or more embodiments of the present invention for identifying a sync mark;

FIG. 6 depicts a communication system including a non-threshold based sync mark detector circuit in accordance with different embodiments of the present invention; and

FIG. 7 shows a storage system including a non-threshold based sync mark detector circuit in accordance with some embodiments of the present invention.

### DETAILED DESCRIPTION OF THE INVENTION

The present inventions are related to systems and methods for data processing, and more particularly to systems and methods for detecting patterns in a data stream.

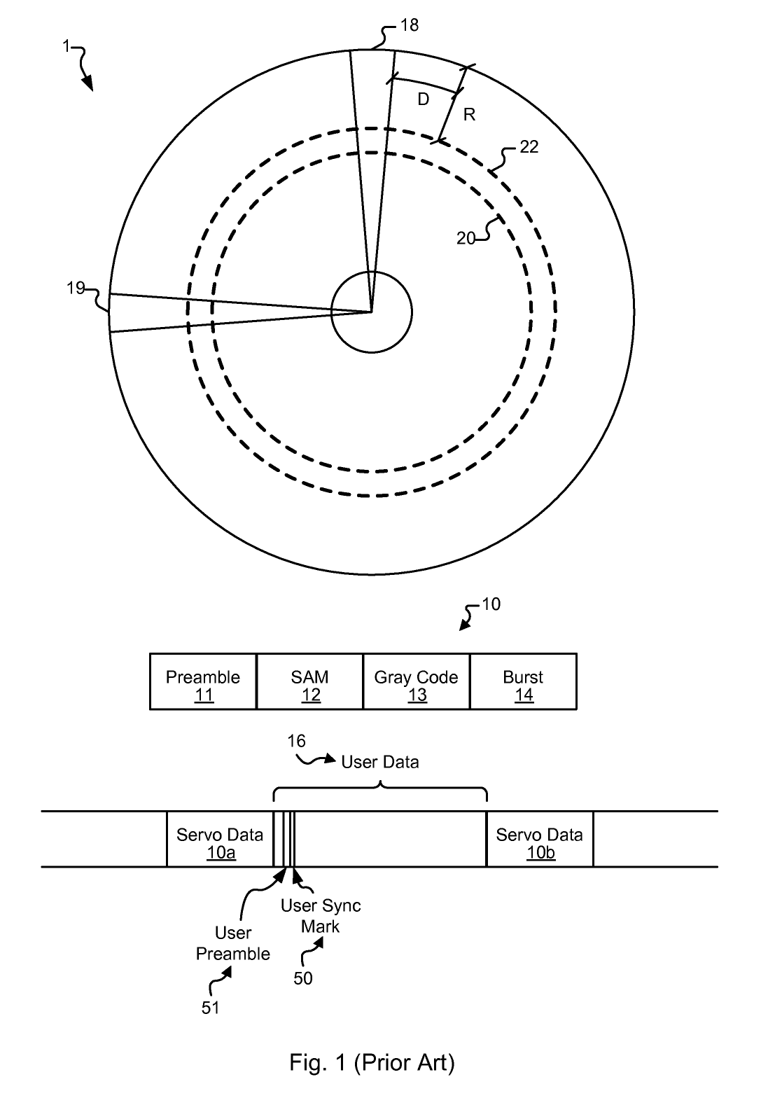

Turning to FIG. 1, a storage medium 1 is shown with two exemplary tracks 20, 22 indicated as dashed lines. The tracks are segregated by servo data written within wedges 19, 18. These wedges include servo data 10 that are used for control and synchronization of a read/write head assembly over a desired location on storage medium 1. In particular, the servo data generally includes a preamble pattern 11 followed by a servo address mark 12 (SAM). Servo address mark 12 is followed by a Gray code 13, and Gray code 13 is followed by burst information 14. It should be noted that while two tracks and two wedges are shown, hundreds of each would typically be included on a given storage medium. Further, it should be noted that a servo data set may have two or more fields of burst information. Yet further, it should be noted that different information may be included in the servo fields such as, for example, repeatable run-out information that may appear after burst information 14.

Between the servo data bit patterns 10a and 10b, a user data region 16 is provided. User data region 16 may include one or more sets of data that are stored to storage medium 1. The data sets may include user synchronization information some of which may be used as a mark to establish a point of reference from which processing of the data within user data region 16 may begin processing.

In operation, storage medium 1 is rotated in relation to a sensor that senses information from the storage medium. In a read operation, the sensor would sense servo data from wedge 19 (i.e., during a servo data period) followed by user data from a user data region between wedge 19 and wedge 18 (i.e., during a user data period) and then servo data from wedge 18. In a write operation, the sensor would sense servo data from wedge 19 then write data to the user data region between wedge 19 and wedge 18. Then, the sensor would be switched to sense a remaining portion of the user data region followed by the servo data from wedge 18. Once the user data region is reached, a user sync mark 50 is detected and used as a reference point from which data processing is performed. User sync mark 50 is preceded by a user preamble 51.

As used herein, the phrase “sync mark” is used in its broadest sense to mean any pattern that may be used to establish a point of reference. Thus, for example, a sync mark may be user sync mark 50 as is known in the art, or one or more portions of servo data bit patterns 10. Based upon the disclosure provided herein, one of ordinary skill in the art may recognize other sync marks that could be used in relation to different embodiments of the present invention.

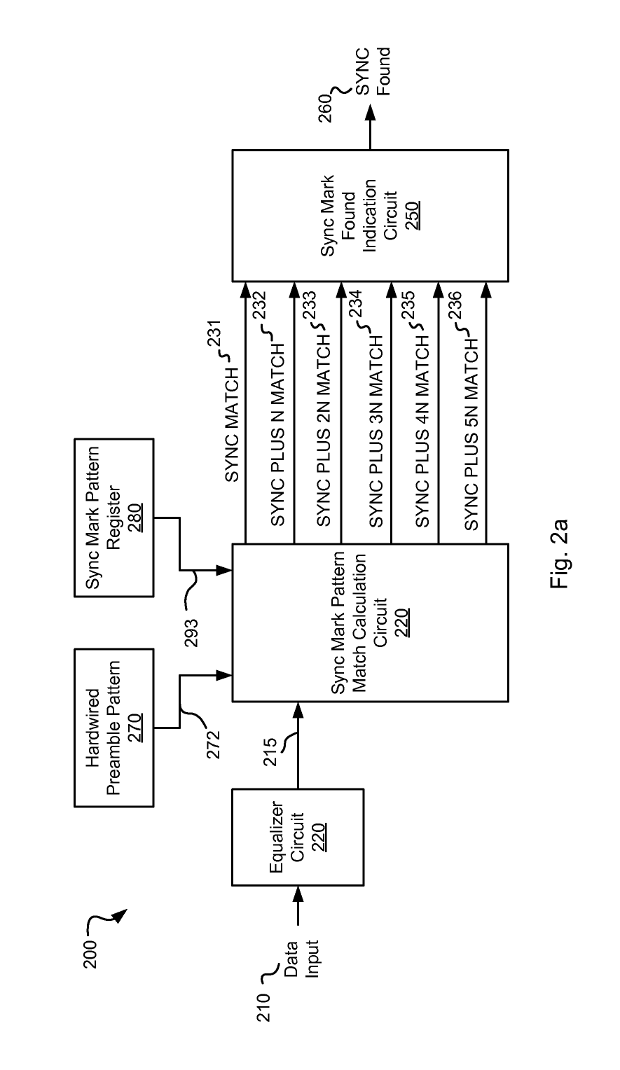

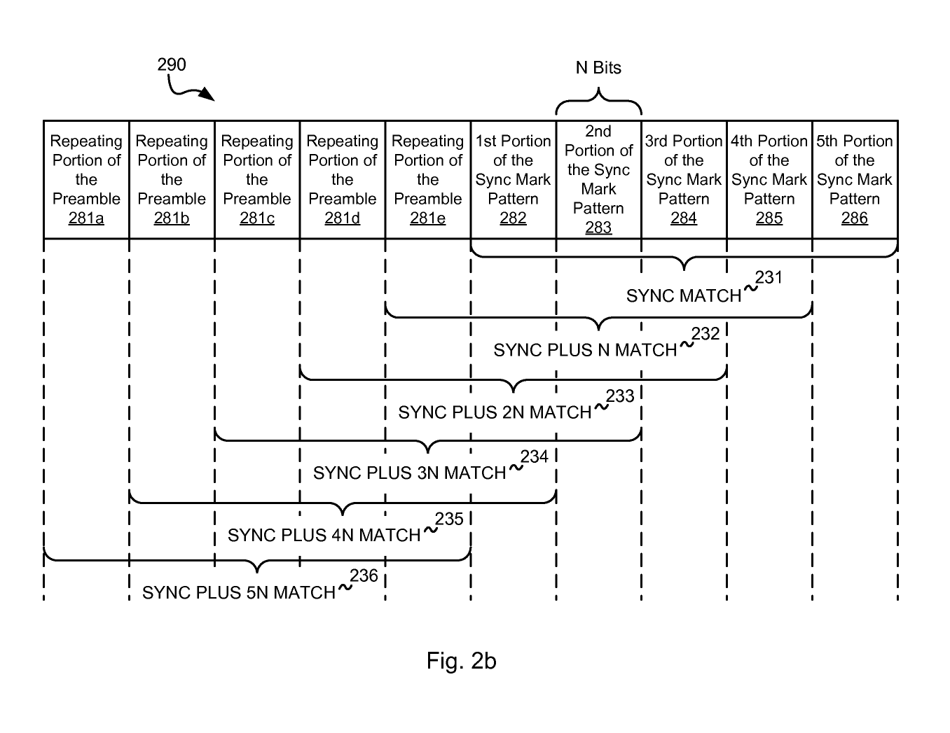

Turning to FIG. 2a, a non-threshold based sync mark detector circuit 200 is shown in accordance with one or more embodiments of the present invention. Sync mark detector circuit 200 includes an equalizer circuit 220 that receives a data input 210 and provides an equalized output 215. In some embodiments, equalizer circuit 210 is a digital finite impulse response filter as are known in the art. Data input 210 may be a series of digital samples. The digital samples may represent, for example, data stored on a storage medium or data received via a wireless communication medium. Based upon the disclosure provided herein, one of ordinary skill in the art will recognize a variety of sources of data input 210.

Equalizer output 215 is provided to a sync mark pattern match calculation circuit 220. Sync mark pattern match calculation circuit 220 compares equalizer output 215 with a preamble pattern 272 from a hardwired preamble pattern 270 and to a sync mark pattern 293 from a sync mark pattern register 280. Sync mark pattern register 280 may either be hard coded, or reprogrammable depending upon the particular implementation. In some embodiments of the present invention, the sync mark stored in sync mark pattern register 280 is a defined pattern of twenty bits in length. In contrast, hardwired preamble pattern 270 includes a repeating portion of a preamble pattern. In some embodiments of the present invention, the preamble that precedes the sync mark pattern repeats every two cycles. As such, the preamble pattern includes twenty or more bits of the preamble repeating as follows: ‘11001100110011001100’. In such a case, preamble pattern 272 is ‘1100’.

The comparison done by sync mark pattern match calculation circuit 220 yields a number of values corresponding to a difference between equalizer output 215 and various components of preamble pattern 272 and sync mark pattern 293. In some particular embodiments of the present invention, the comparison is a Euclidean distance between equalizer output 215 and the particular pattern to which it is being compared in accordance with the following equation:

$$Output = {\sum }_{k = 0}^{i} {( equalizer {output}_{k} - comparison {pattern}_{k} )}^{2} ,$$

where k represents an individual sample value. In particular, sync mark pattern match calculation circuit 220 provides a sync match output 231 that corresponds to a comparison between the bits of sync mark pattern 293 and the same number of bits of equalizer output 215. Sync mark pattern match calculation circuit 220 also provides: a sync plus N match output 232 that corresponds to a comparison between the bits of sync mark pattern 293 less the most recent N bits of sync mark pattern 293, and the same number of bits of equalizer output 215; a sync plus 2N match output 233 that corresponds to a comparison between the bits of sync mark pattern 293 less the most recent 2N bits of sync mark pattern 293, and the same number of bits of equalizer output 215; a sync plus 3N match output 234 that corresponds to a comparison between the bits of sync mark pattern 293 less the most recent 3N bits of sync mark pattern 293, and the same number of bits of equalizer output 215; a sync plus 4N match output 235 that corresponds to a comparison between the bits of sync mark pattern 293 less the most recent 4N bits of sync mark pattern 293, and the same number of bits of equalizer output 215; a sync plus 5N match output 236 that corresponds to a comparison between the bits of sync mark pattern 293 less the most recent 5N bits of sync mark pattern 293, and the same number of bits of equalizer output 215. In one particular embodiment of the present invention, sync mark pattern 293 is twenty bits in length, and the value of N is four bits. Based upon the disclosure provided herein, one of ordinary skill in the art will recognize a variety of lengths of sync bit patterns and corresponding values of N that may be used in relation to different embodiments of the present invention.

FIG. 2b graphically shows comparisons yielding the various outputs of a sync mark pattern match calculation circuit 220 that were described above. In particular, a time line 290 shows N-bit preamble pattern 272 repeated a number of times (i.e., elements 281a, 281b, 281c, 281d, 281e) and a number of different N-bit portions (i.e., elements 282, 283, 284, 285, 286) of sync mark pattern 293 lined up in time as they would be expected to be received as part of an incoming data stream. As shown, sync match output 231 corresponds to a comparison (e.g., a Euclidean difference) between equalizer output 215 and the five consecutive N-bit portions 282, 283, 284, 285, 286 of sync mark pattern 293. Sync plus N match output 232 corresponds to a comparison (e.g., a Euclidean difference) between equalizer output 215 and one N-bit portion of the preamble 281e appended with the four least recent N-bit portions 282, 283, 284, 285 of sync mark pattern 293. Sync plus 2N match output 233 corresponds to a comparison (e.g., a Euclidean difference) between equalizer output 215 and two N-bit portions of the preamble 281d, 281e appended with the three least recent N-bit portions 282, 283, 284 of sync mark pattern 293. Sync plus 3N match output 234 corresponds to a comparison (e.g., a Euclidean difference) between equalizer output 215 and three N-bit portions of the preamble 281c, 281d, 281e appended with the two least recent N-bit portions 282, 283 of sync mark pattern 293. Sync plus 4N match output 235 corresponds to a comparison (e.g., a Euclidean difference) between equalizer output 215 and four N-bit portions of the preamble 281b, 281c, 281d, 281e appended with the least recent N-bit portion 282 of sync mark pattern 293. Sync plus 5N match output 236 corresponds to a comparison (e.g., a Euclidean difference) between equalizer output 215 and five N-bit portions of the preamble 281a, 281b, 281c, 281d, 281e.

Sync match output 231, sync plus N match output 232, sync plus 2N match output 233, sync plus 3N match output 234, sync plus 4N match output 235 and sync plus 5N match output 236 are provided to a sync mark found indication circuit 250. Sync mark found indication circuit 250 combines the received inputs to determine whether a sync mark was found. When a sync mark is found, a sync found output 260 is asserted.

In one particular embodiment of the present invention where the comparisons performed to determine sync match output 231, sync plus N match output 232, sync plus 2N match output 233, sync plus 3N match output 234, sync plus 4N match output 235 and sync plus 5N match output 236 are calculations of the Euclidean distance from a defined pattern to an input data set, the values of the aforementioned inputs are each lower when the respective patterns are closer to matching. In such a case, sync found output 260 is asserted whenever the value provided as sync match output 231 is less than any of the values provided as sync plus N match output 232, sync plus 2N match output 233, sync plus 3N match output 234, sync plus 4N match output 235 and sync plus 5N match output 236. The following pseudocode represents the logic implemented in such an embodiment of sync mark found indication circuit 250:

If (Sync Match Output 231 < sync plus N match output 232 &&

Sync Match Output 231 < sync plus 2N match output 233 &&
Sync Match Output 231 < sync plus 3N match output 234 &&
Sync Match Output 231 < sync plus 4N match output 235 &&
Sync Match Output 231 < sync plus 5N match output 236)

{

Sync Found Output 260 = asserted

}
Else
{

Sync Found Output 260 = de-asserted

}

As will be appreciated from the forgoing discussion, a sync mark is found without a comparison between a sync mark value and a threshold value. Because of this, sync mark detector circuit 200 is not sensitive to improperly tuned threshold values. As just some of the many advantages of sync mark detector circuit 200, threshold tuning can be eliminated and the likelihood of a sync mark failure (either misidentifying a data set as a sync mark or failing to properly identify a sync mark) may be reduced. Based on the disclosure provided herein, one of ordinary skill in the art will recognize a variety of other advantages that may be achieved in accordance with different embodiments of the present invention.

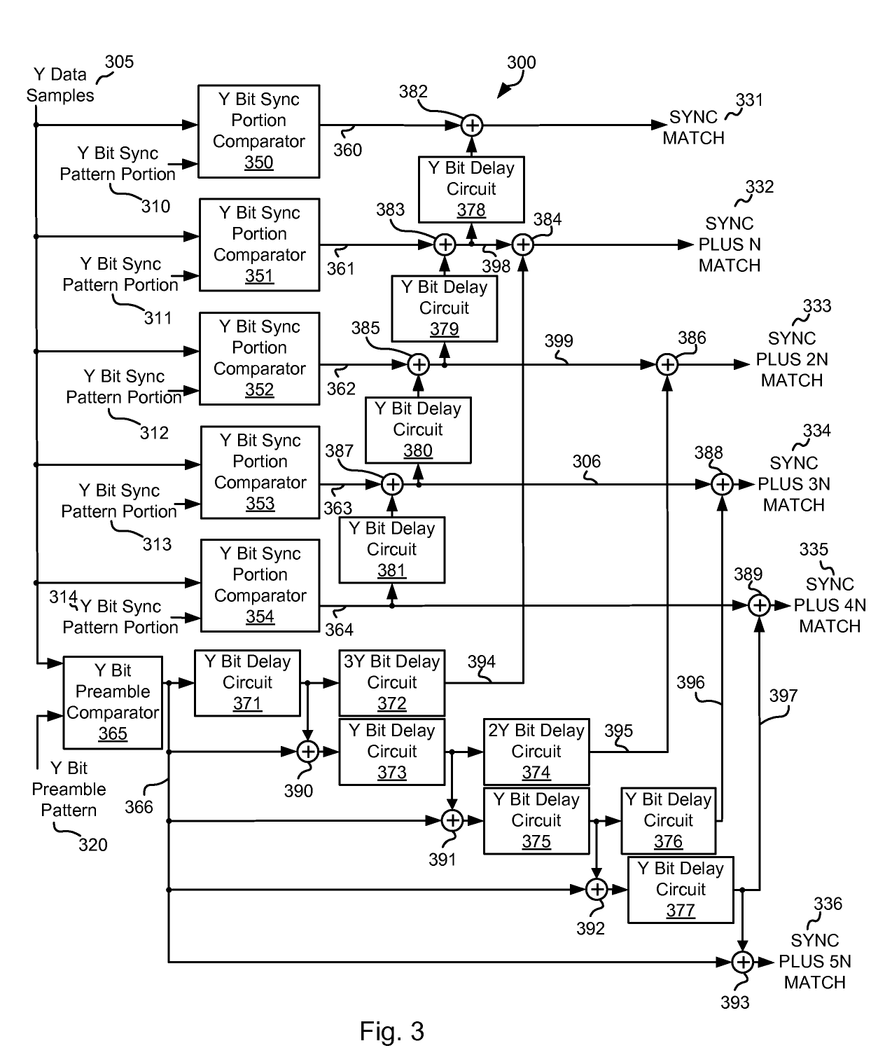

Turning to FIG. 3, a sync mark pattern match calculation circuit 300 is shown in accordance with various embodiments of the present invention. Sync mark pattern match calculation circuit 300 may be used in place of sync mark pattern match calculation circuit 220 of FIG. 2a above. Circuit 300 includes: a Y-bit sync portion comparator circuit 350 that receives a data input Y samples 305 at a time and compares the Y samples with the least significant Y bits of a sync pattern portion 310; a Y-bit sync portion comparator circuit 351 that receives Y samples 305 and compares the Y samples with the next least significant Y bits of a sync pattern portion 311; a Y-bit sync portion comparator circuit 352 that receives Y samples 305 and compares the Y samples with the next least significant Y bits of a sync pattern portion 312; a Y-bit sync portion comparator circuit 353 that receives Y samples 305 and compares the Y samples with the next least significant Y bits of a sync pattern portion 313; a Y-bit sync portion comparator circuit 354 that receives Y samples 305 and compares the Y samples with the next least significant Y bits of a sync pattern portion 314; and a Y-bit preamble comparator circuit 365 that receives Y samples 305 and compares the Y samples with a Y bit preamble pattern 320.

Where circuit 300 is used in place of sync mark pattern match calculation circuit 220, Y is equivalent to N, Y bit preamble pattern 320 is equivalent to N-bit preamble pattern 272, Y bit sync pattern portion 310 is equivalent to bits (N−1 . . . zero) of sync mark pattern 293, Y bit sync pattern portion 311 is equivalent to bits (2N−1 . . . N) of sync mark pattern 293, Y bit sync pattern portion 312 is equivalent to bits (3N−1 . . . 2N) of sync mark pattern 293, Y bit sync pattern portion 313 is equivalent to bits (4N−1 . . . 3N) of sync mark pattern 293, and Y bit sync pattern portion 314 is equivalent to bits (5N−1 . . . 4N) of sync mark pattern 293.

In some embodiments of the present invention, each of Y-bit sync portion comparator circuit 350, Y-bit sync portion comparator circuit 351, Y-bit sync portion comparator circuit 352, Y-bit sync portion comparator circuit 353, Y-bit sync portion comparator circuit 354, Y-bit preamble comparator circuit 365 are each Euclidean calculation circuits. The Euclidean calculation circuits calculate a Euclidean distance between the received Y samples 305 and the respective pattern portion in accordance with the following equation:

$$Output = {\sum }_{k = 0}^{i} {( Y Sample {305}_{k} - {Pattern}_{k} )}^{2} .$$

Thus, an output 360 from Y-bit sync portion comparator circuit 350 is equivalent to:

$$Output 360 = {\sum }_{k = 0}^{i} {( Y Sample {305}_{k} - Sync Pattern {Portion}_{k} )}^{2} ,$$

where i=Y−1. Similarly, an output 361 from Y-bit sync portion comparator circuit 351 is equivalent to:

$$Output 361 = {\sum }_{k = 0}^{i} {( Y Sample {305}_{k} - Sync Pattern {Portion}_{Y + k} )}^{2} ,$$

where i=Y−1. Similarly, an output 362 from Y-bit sync portion comparator circuit 352 is equivalent to:

$$Output 362 = {\sum }_{k = 0}^{i} {( Y Sample {305}_{k} - Sync Pattern {Portion}_{2 Y + k} )}^{2} ,$$

where i=Y−1. Similarly, an output 363 from Y-bit sync portion comparator circuit 353 is equivalent to:

$$Output 363 = {\sum }_{k = 0}^{i} {( Y Sample {305}_{k} - Sync Pattern {Portion}_{3 Y + k} )}^{2} ,$$

where i=Y−1. Similarly, an output 364 from Y-bit sync portion comparator circuit 352 is equivalent to:

$$Output 364 = {\sum }_{k = 0}^{i} {( Y Sample {305}_{k} - Sync Pattern {Portion}_{4 Y + k} )}^{2} ,$$

where i=Y−1. An output 366 from Y-bit preamble comparator circuit 365 is equivalent to:

$$Output 366 = {\sum }_{k = 0}^{i} {( Y Sample {305}_{k} - Preamble {Pattern}_{k} )}^{2} ,$$

where i=Y−1.

Output 366 is provided to a Y bit delay circuit 371 that delays the input by Y sample periods. The output of Y bit delay circuit 371 is provided to a 3Y delay circuit 372 that delays the input by 3*Y sample periods to yield a delayed preamble comparison value 394. Delayed preamble comparison value 394 is comparable to a comparison with element 281e of FIG. 2b. In addition, the output of Y bit delay circuit 371 is provided to a summation circuit 390 where it is summed with output 366 to yield an output provided to another Y bit delay circuit 373 that delays the input by Y sample periods. The output from Y bit delay circuit 373 is provided to a 2Y delay circuit 374 that delays the input by 2*Y sample periods to yield a delayed preamble comparison value 395. Delayed preamble comparison value 395 is comparable to a comparison with the combination of element 281d and element 281e of FIG. 2b. In addition, the output of Y bit delay circuit 373 is provided to a summation circuit 391 where it is summed with output 366 to yield an output provided to another Y bit delay circuit 375 that delays the input by Y sample periods. The output from Y bit delay circuit 375 is provided to another Y bit delay circuit 376 that delays the input by Y sample periods to yield a delayed preamble comparison value 396. Delayed preamble comparison value 396 is comparable to a comparison with the combination of element 281c, element 281d and element 281e of FIG. 2b. In addition, the output of Y bit delay circuit 375 is provided to a summation circuit 392 where it is summed with output 366 to yield an output provided to another Y bit delay circuit 377 that delays the input by Y sample periods to yield a delayed preamble comparison value 397. Delayed preamble comparison value 397 is comparable to a comparison with the combination of element 281b, element 281c, element 281d and element 281e of FIG. 2b. In addition, the output of Y bit delay circuit 377 is provided to a summation circuit 393 where it is summed with output 366 to yield a sync plus 5N match signal 336. The value of sync plus 5N match signal 336 is comparable to a comparison with the combination of element 281a, element 281b, element 281c, element 281d and element 281e of FIG. 2b. Where circuit 300 is used in place of sync mark pattern match calculation circuit 220, sync plus 5N match signal 336 is equivalent to sync plus 5N match signal 236.

Output 364 is provided to a summation circuit 389 where it is summed with delayed preamble comparison value 397 to yield sync plus 4N match signal 335. The value of sync plus 4N match signal 335 is comparable to a comparison with the combination of element 281b, element 281c, element 281d, element 281e and element 282 of FIG. 2b. Where circuit 300 is used in place of sync mark pattern match calculation circuit 220, sync plus 4N match signal 335 is equivalent to sync plus 4N match signal 235.

In addition, output 364 is provided to a Y-bit delay circuit 381 that delays the input by Y sample periods. The output of Y-bit delay circuit 381 is provided to a summation circuit 387 where it is summed with output 363 to yield a summed output 306. Summed output 306 is provided to a summation circuit 388 where it is summed with delayed preamble comparison value 396 to yield sync plus 3N match signal 334. The value of sync plus 3N match signal 334 is comparable to a comparison with the combination of element 281c, element 281d, element 281e, element 282 and element 283 of FIG. 2b. Where circuit 300 is used in place of sync mark pattern match calculation circuit 220, sync plus 3N match signal 334 is equivalent to sync plus 3N match signal 234.

In addition, summed output 306 is provided to a Y-bit delay circuit 380 that delays the input by Y sample periods. The output of Y-bit delay circuit 380 is provided to a summation circuit 385 where it is summed with output 362 to yield a summed output 399. Summed output 399 is provided to a summation circuit 386 where it is summed with delayed preamble comparison value 395 to yield sync plus 2N match signal 333. The value of sync plus 2N match signal 333 is comparable to a comparison with the combination of element 281d, element 281e, element 282, element 283 and element 284 of FIG. 2b. Where circuit 300 is used in place of sync mark pattern match calculation circuit 220, sync plus 2N match signal 333 is equivalent to sync plus 2N match signal 233.

In addition, summed output 399 is provided to a Y-bit delay circuit 379 that delays the input by Y sample periods. The output of Y-bit delay circuit 379 is provided to a summation circuit 383 where it is summed with output 361 to yield a summed output 398. Summed output 398 is provided to a summation circuit 384 where it is summed with delayed preamble comparison value 394 to yield sync plus N match signal 332. The value of sync plus N match signal 332 is comparable to a comparison with the combination of element 281e, element 282, element 283, element 284 and element 285 of FIG. 2b. Where circuit 300 is used in place of sync mark pattern match calculation circuit 220, sync plus N match signal 332 is equivalent to sync plus N match signal 232.

In addition, summed output 398 is provided to a Y-bit delay circuit 378 that delays the input by Y sample periods. The output of Y-bit delay circuit 378 is provided to a summation circuit 382 where it is summed with output 360 to sync match signal 331. The value of sync match signal 331 is comparable to a comparison with the combination of element 282, element 283, element 284, element 285 and element 286 of FIG. 2b. Where circuit 300 is used in place of sync mark pattern match calculation circuit 220, sync match signal 331 is equivalent to sync match signal 231.

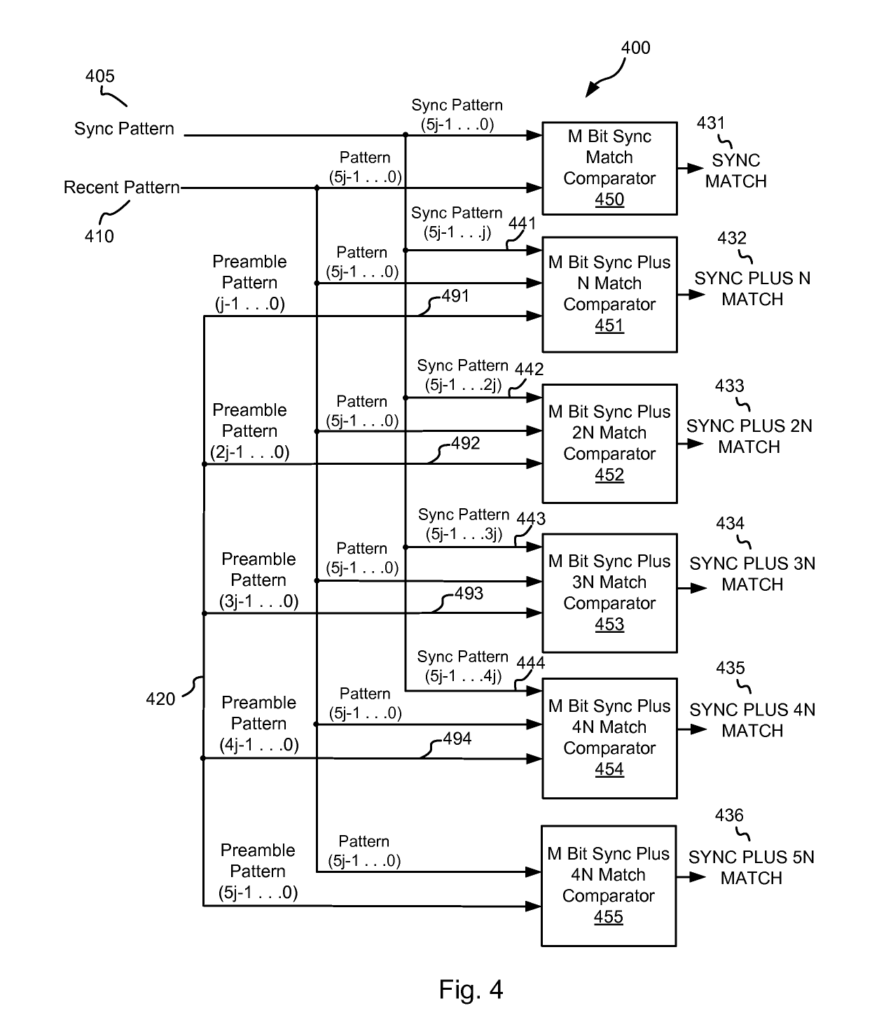

Turning to FIG. 4, another sync mark pattern match calculation circuit 400 is depicted in accordance with some embodiments of the present invention. Sync mark pattern match calculation circuit 400 may be used in place of sync mark pattern match calculation circuit 220 of FIG. 2a above. Circuit 400 includes: an M-bit sync match comparator circuit 450 that receives a sync pattern 405 and a recent pattern 410; an M-bit sync plus N match comparator circuit 451 that receives recent pattern 410, a subset of sync pattern 405 (i.e., sync pattern (5j−1 . . . j) 441), and a subset of preamble pattern 420 (preamble pattern (j−1 . . . 0) 491); an M-bit sync plus 2N match comparator circuit 452 that receives recent pattern 410, a subset of sync pattern 405 (i.e., sync pattern (5j−1 . . . 2j) 442), and a subset of preamble pattern 420 (preamble pattern (2j−1 . . . 0) 492); an M-bit sync plus 3N match comparator circuit 453 that receives recent pattern 410, a subset of sync pattern 405 (i.e., sync pattern (5j−1 . . . 3j) 443), and a subset of preamble pattern 420 (preamble pattern (3j−1 . . . 0) 493); an M-bit sync plus 4N match comparator circuit 454 that receives recent pattern 410, a subset of sync pattern 405 (i.e., sync pattern (5j−1 . . . 4j) 444), and a subset of preamble pattern 420 (preamble pattern (4j−1 . . . 0) 494); and an M-bit sync plus 2N match comparator circuit 452 that receives recent pattern 410, and preamble pattern 420. Each of preamble pattern 420 and sync pattern 405 are M-bits long. Recent pattern 410 is the most recently received M-bits.

In some embodiments of the present invention, each of M-bit sync match comparator circuit 450, M-bit sync plus N match comparator circuit 451, M-bit sync plus 2N match comparator circuit 452, M-bit sync plus 3N match comparator circuit 453, and M-bit sync plus 4N match comparator circuit 454, and M-bit sync plus 5N match comparator circuit 455 are Euclidean calculation circuits. The Euclidean calculation circuits calculate a Euclidean distance between the received inputs (portions of recent pattern 410) and the corresponding portions of sync pattern 405 and preamble pattern 420. In particular, M-bit sync match comparator circuit 450 provides a sync match output 431 in accordance with the following equation:

$$Output 431 = {\sum }_{k = 0}^{5 j - 1} {( {Pattern}_{k} - Sync {Pattern}_{k} )}^{2} ,$$

where 5j−1 corresponds to the number of bits in both sync pattern 405 and preamble pattern 420. Similarly, a sync match output 432 from M-bit sync plus N match comparator circuit 451 is equivalent to:

$$Output 432 = {\sum }_{k = j}^{5 j - 1} {( {Pattern}_{k - j} - Sync {Pattern}_{k} )}^{2} + {\sum }_{k = 0}^{j - 1} {( {Pattern}_{k + 4 j} - Preamble {Pattern}_{k} )}^{2} ,$$

where 5j−1 corresponds to the number of bits in both sync pattern 405 and preamble pattern 420. Similarly, a sync match output 433 from M-bit sync plus 2N match comparator circuit 452 is equivalent to:

$$Output 433 = {\sum }_{k = 2 j}^{5 j - 1} {( {Pattern}_{k - 2 j} - Sync {Pattern}_{k} )}^{2} + {\sum }_{k = 0}^{2 j - 1} {( {Pattern}_{k + 3 j} - Preamble {Pattern}_{k} )}^{2} ,$$

where 5j−1 corresponds to the number of bits in both sync pattern 405 and preamble pattern 420. Similarly, a sync match output 434 from M-bit sync plus 3N match comparator circuit 453 is equivalent to:

$$Output 434 = {\sum }_{k = 3 j}^{5 j - 1} {( {Pattern}_{k - 3 j} - Sync {Pattern}_{k} )}^{2} + {\sum }_{k = 0}^{3 j - 1} {( {Pattern}_{k + 2 j} - Preamble {Pattern}_{k} )}^{2} ,$$

where 5j−1 corresponds to the number of bits in both sync pattern 405 and preamble pattern 420. Similarly, a sync match output 435 from M-bit sync plus 4N match comparator circuit 454 is equivalent to:

$$Output 435 = {\sum }_{k = 4 j}^{5 j - 1} {( {Pattern}_{k - 4 j} - Sync {Pattern}_{k} )}^{2} + {\sum }_{k = 0}^{4 j - 1} {( {Pattern}_{k + 1 j} - Preamble {Pattern}_{k} )}^{2} ,$$

where 5j−1 corresponds to the number of bits in both sync pattern 405 and preamble pattern 420. Similarly, a sync match output 436 from M-bit sync plus 5N match comparator circuit 455 is equivalent to:

$$Output 436 = {\sum }_{k = 0}^{5 j - 1} {( {Pattern}_{k} - Preamble {Pattern}_{k} )}^{2} ,$$

where 5j−1 corresponds to the number of bits in both sync pattern 405 and preamble pattern 420.

Where circuit 400 is used in place of sync mark pattern match calculation circuit 220, sync pattern 405 is equivalent to sync mark pattern 293, recent pattern 410 is the most recent M bits of data input 210, prior pattern 420 is the M bits of data input 210 directly preceding recent pattern 410, preamble pattern 420 is equivalent to preamble pattern 272, output 431 is equivalent to sync match output 231 (e.g., comparable to the comparison with the combination of element 282, element 283, element 284, element 285 and element 286 of FIG. 2b), output 432 is equivalent to sync plus N match output 232 (e.g., comparable to the comparison with the combination of element 281e, element 282, element 283, element 284 and element 285 of FIG. 2b), output 433 is equivalent to sync plus 2N match output 233 (e.g., comparable to the comparison with the combination of element 281d, element 281e, element 282, element 283 and element 284 of FIG. 2b), output 434 is equivalent to sync plus 3N match output 234 (e.g., comparable to the comparison with the combination of element 281c, element 281d, element 281e, element 282 and element 283 of FIG. 2b), output 435 is equivalent to sync plus 4N match output 235 (e.g., comparable to the comparison with the combination of element 281b, element 281c, element 281d, element 281e and element 282 of FIG. 2b), and output 436 is equivalent to sync plus 5N match output 236 (e.g., comparable to the comparison with the combination of element 281a, element 281b, element 281c, element 281d and element 281e of FIG. 2b).

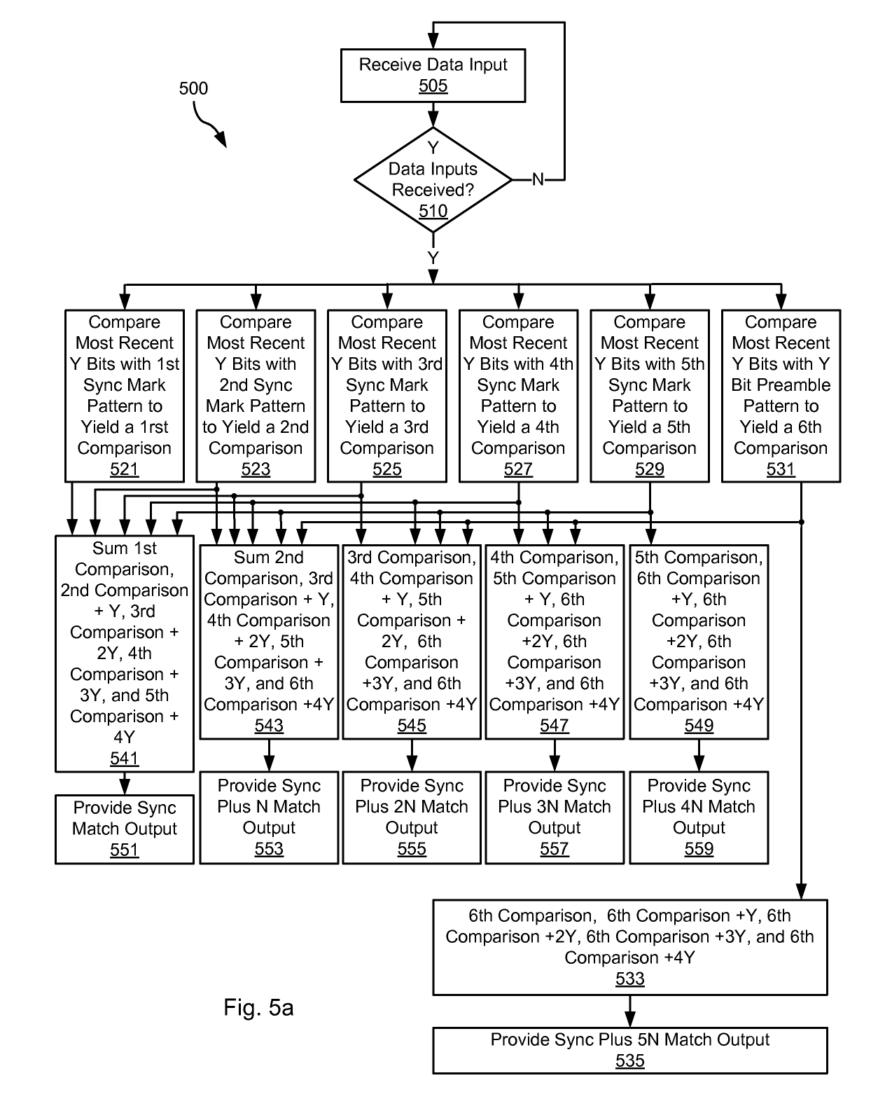

Turning to FIGS. 5a-5b, are flow diagrams 500, 599 showing a method in accordance with one or more embodiments of the present invention for identifying a sync mark. Following flow diagram 500, data samples are received as a data input (block 505). The received data samples may be derived from, for example, a storage medium or a wireless transfer medium. Based upon the disclosure provided herein, one of ordinary skill in the art will recognize a variety of sources of the data samples. It is determined whether Y samples have been received (block 510). In some embodiments of the present invention, Y is four bits. Based upon the disclosure provided herein, one of ordinary skill in the art will recognize other values for Y that may be used in relation to different embodiments of the present invention. Where Y samples have not yet been received (block 510), the process returns to await additional samples (block 505).

Alternatively, where Y samples have been received (block 510), the most recently received Y bits are compared with various patterns. In particular, the most recently received Y bits are compared with a first sync mark pattern to yield a first comparison (i.e., the Y least significant bits of the sync mark pattern) (block 521). In some cases, the comparison is a Euclidean distance between the received four bits and the first sync mark pattern in accordance with the following equation:

$$First Comparison = {\sum }_{k = 0}^{Y - 1} {( Y {Sample}_{k} - First Sync Mark {Pattern}_{k} )}^{2} .$$

In addition, the most recently received Y bits are compared with a second sync mark pattern to yield a second comparison (i.e., the next Y least significant bits of the sync mark pattern) (block 523). In some cases, the comparison is a Euclidean distance between the received four bits and the second sync mark pattern in accordance with the following equation:

$$Second Comparison = {\sum }_{k = 0}^{Y - 1} {( Y {Sample}_{k} - Second Sync Mark {Pattern}_{k + Y} )}^{2} .$$

In addition, the most recently received Y bits are compared with a third sync mark pattern to yield a third comparison (i.e., the next Y least significant bits of the sync mark pattern) (block 525). In some cases, the comparison is a Euclidean distance between the received four bits and the third sync mark pattern in accordance with the following equation:

$$Third Comparison = {\sum }_{k = 0}^{Y - 1} {( Y {Sample}_{k} - Third Sync Mark {Pattern}_{k + 2 Y} )}^{2} .$$

In addition, the most recently received Y bits are compared with a fourth sync mark pattern to yield a fourth comparison (i.e., the next Y least significant bits of the sync mark pattern) (block 527). In some cases, the comparison is a Euclidean distance between the received four bits and the fourth sync mark pattern in accordance with the following equation:

$$Fourth Comparison = {\sum }_{k = 0}^{Y - 1} {( Y {Sample}_{k} - Fourth Sync Mark {Pattern}_{k + 3 Y} )}^{2} .$$

In addition, the most recently received Y bits are compared with a fifth sync mark pattern to yield a fifth comparison (i.e., the next Y least significant bits of the sync mark pattern) (block 529). In some cases, the comparison is a Euclidean distance between the received four bits and the fifth sync mark pattern in accordance with the following equation:

$$Fifth Comparison = {\sum }_{k = 0}^{Y - 1} {( Y {Sample}_{k} - Fifth Sync Mark {Pattern}_{k + 3 Y} )}^{2} .$$

In addition, the most recently received Y bits are compared with a Y bit preamble pattern to yield a sixth comparison (i.e., the next Y least significant bits of the sync mark pattern) (block 529). In some cases, the comparison is a Euclidean distance between the received four bits and the fifth sync mark pattern in accordance with the following equation:

$$Sixth Comparison = {\sum }_{k = 0}^{Y - 1} {( Y {Sample}_{k} - Preamble {Pattern}_{k} )}^{2} .$$

The aforementioned comparison outputs are then combined to yield interim outputs. In particular, the first comparison is summed with the second comparison delayed by Y bit periods, the third comparison delayed by 2Y bit periods, the fourth comparison delayed by 3Y bit periods, and the fifth comparison delayed by 4Y bit periods to yield a first interim output (block 541). This first interim output is provided as a sync match output (block 551). In addition, the second comparison is summed with the third comparison delayed by Y bit periods, the fourth comparison delayed by 2Y bit periods, the fifth comparison delayed by 3Y bit periods, and the sixth comparison delayed by 4Y bit periods to yield a second interim output (block 543). This first interim output is provided as a sync plus N match output (block 553). In addition, the third comparison is summed with the fourth comparison delayed by Y bit periods, the fifth comparison delayed by 2Y bit periods, the sixth comparison delayed by 3Y bit periods, and the sixth comparison delayed by 4Y bit periods to yield a second interim output (block 545). This first interim output is provided as a sync plus 2N match output (block 555). In addition, the fourth comparison is summed with the fifth comparison delayed by Y bit periods, the sixth comparison delayed by 2Y bit periods, the sixth comparison delayed by 3Y bit periods, and the sixth comparison delayed by 4Y bit periods to yield a second interim output (block 547). This first interim output is provided as a sync plus 3N match output (block 557). In addition, the fifth comparison is summed with the sixth comparison delayed by Y bit periods, the sixth comparison delayed by 2Y bit periods, the sixth comparison delayed by 3Y bit periods, and the sixth comparison delayed by 4Y bit periods to yield a second interim output (block 549). This first interim output is provided as a sync plus 4N match output (block 559). In addition, the sixth comparison is summed with the sixth comparison delayed by Y bit periods, the sixth comparison delayed by 2Y bit periods, the sixth comparison delayed by 3Y bit periods, and the sixth comparison delayed by 4Y bit periods to yield a second interim output (block 533). This first interim output is provided as a sync plus 5N match output (block 535).

Following flow diagram 599, each of the aforementioned sync match output, the sync plus N match output, the sync plus 2N match output, the sync plus 3N match output, the sync plus 4N match output, and the sync plus 5N match output are used to determine the occurrence of a sync mark (block 585). In some embodiments, the determination is done in accordance with the following pseudocode:

If (the Sync Match Output < the sync plus N match output &&

the Sync Match Output < the sync plus 2N match output &&
the Sync Match Output < the sync plus 3N match output &&
the Sync Match Output < the sync plus 4N match output &&
the Sync Match Output < the sync plus 5N match output)

{

the Sync Mark is Found

}
Else
{

the Sync Mark is Found

}

Where it is determined that the sync mark was found (block 590), a sync mark found output is asserted (block 595).

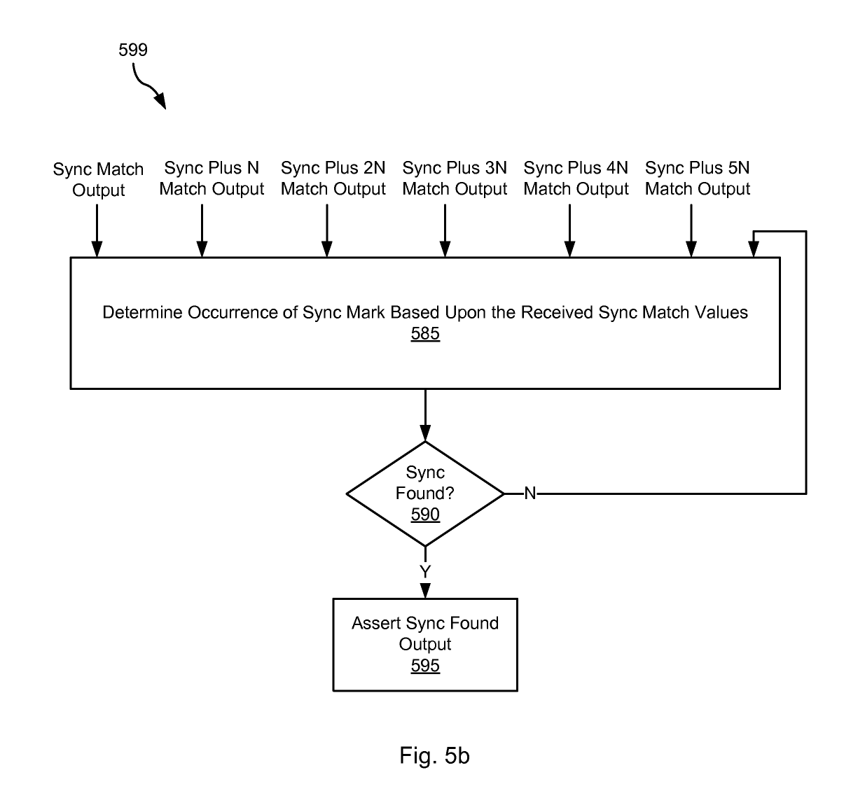

Turning to FIG. 6, a communication system 600 including a receiver 620 with a non-threshold based sync mark detector circuit is shown in accordance with different embodiments of the present invention. Communication system 600 includes a transmitter 610 that is operable to transmit encoded information via a transfer medium 630 as is known in the art. The encoded data is received from transfer medium 630 by receiver 620. Receiver 620 incorporates a non-threshold based sync mark detector circuit. The a non-threshold based sync mark detector circuit may be similar to that discussed above in relation to one or more of relation to FIGS. 2-4, and/or may operate in accordance with the method discussed above in relation to FIGS. 5a-5b.

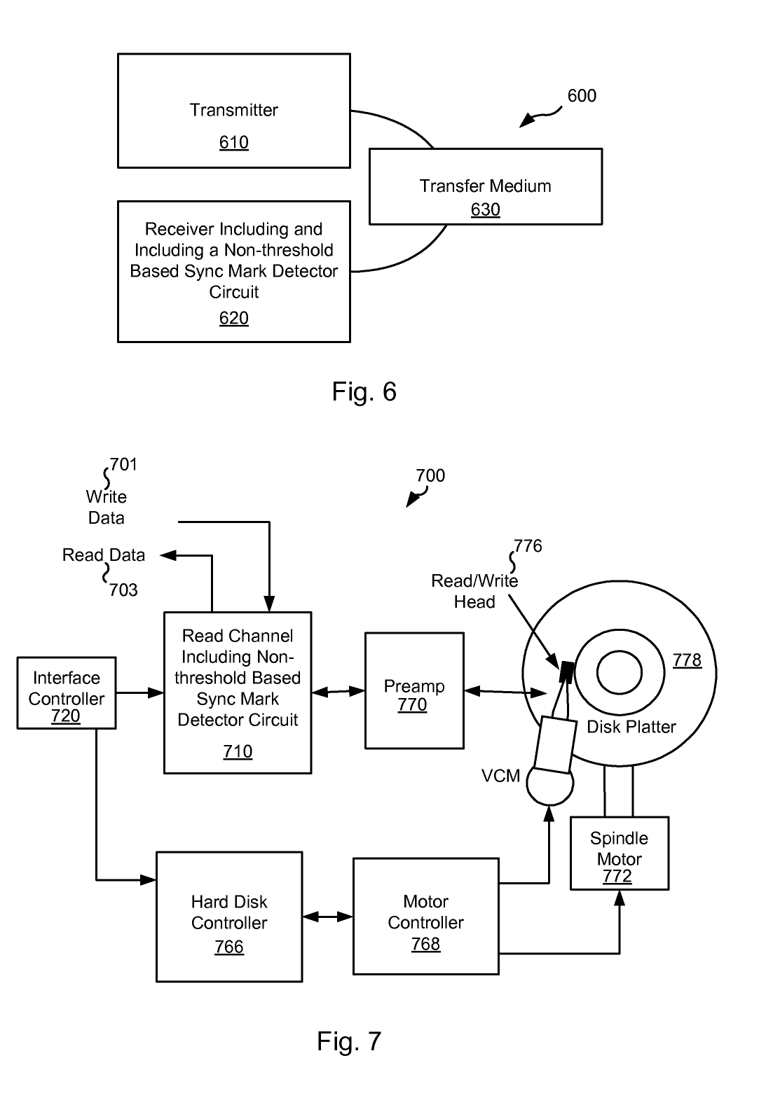

Turning to FIG. 7, a storage system 700 including a read channel circuit 710 with a non-threshold based sync mark detector circuit is shown in accordance with various embodiments of the present invention. Storage system 700 may be, for example, a hard disk drive. Storage system 700 also includes a preamplifier 770, an interface controller 720, a hard disk controller 766, a motor controller 768, a spindle motor 772, a disk platter 778, and a read/write head 776. Interface controller 720 controls addressing and timing of data to/from disk platter 778. The data on disk platter 778 consists of groups of magnetic signals that may be detected by read/write head assembly 776 when the assembly is properly positioned over disk platter 778. In one embodiment, disk platter 778 includes magnetic signals recorded in accordance with either a longitudinal or a perpendicular recording scheme.

In a typical read operation, read/write head assembly 776 is accurately positioned by motor controller 768 over a desired data track on disk platter 778. Motor controller 768 both positions read/write head assembly 776 in relation to disk platter 778 and drives spindle motor 772 by moving read/write head assembly to the proper data track on disk platter 778 under the direction of hard disk controller 766. Spindle motor 772 spins disk platter 778 at a determined spin rate (RPMs). Once read/write head assembly 778 is positioned adjacent the proper data track, magnetic signals representing data on disk platter 778 are sensed by read/write head assembly 776 as disk platter 778 is rotated by spindle motor 772. The sensed magnetic signals are provided as a continuous, minute analog signal representative of the magnetic data on disk platter 778. This minute analog signal is transferred from read/write head assembly 776 to read channel module 764 via preamplifier 770. Preamplifier 770 is operable to amplify the minute analog signals accessed from disk platter 778. In turn, read channel circuit 710 decodes and digitizes the received analog signal to recreate the information originally written to disk platter 778. This data is provided as read data 703 to a receiving circuit. As part of decoding the received information, read channel circuit 710 performs a sync mark detection process. Such a sync mark detection process may be performed using a sync mark detector circuit that may be similar to one or more of those discussed above in relation to FIGS. 2-4. The sync mark detection process may be done in accordance with the method discussed above in relation to FIGS. 5a-5b. A write operation is substantially the opposite of the preceding read operation with write data 701 being provided to read channel circuit 710. This data is then encoded and written to disk platter 778.

It should be noted that storage system 700 may be integrated into a larger storage system such as, for example, a RAID (redundant array of inexpensive disks or redundant array of independent disks) based storage system. It should also be noted that various functions or blocks of storage system 700 may be implemented in either software or firmware, while other functions or blocks are implemented in hardware.

It should be noted that the various blocks discussed in the above application may be implemented in integrated circuits along with other functionality. Such integrated circuits may include all of the functions of a given block, system or circuit, or only a subset of the block, system or circuit. Further, elements of the blocks, systems or circuits may be implemented across multiple integrated circuits. Such integrated circuits may be any type of integrated circuit known in the art including, but are not limited to, a monolithic integrated circuit, a flip chip integrated circuit, a multichip module integrated circuit, and/or a mixed signal integrated circuit. It should also be noted that various functions of the blocks, systems or circuits discussed herein may be implemented in either software or firmware. In some such cases, the entire system, block or circuit may be implemented using its software or firmware equivalent. In other cases, the one part of a given system, block or circuit may be implemented in software or firmware, while other parts are implemented in hardware.

In conclusion, the invention provides novel systems, devices, methods and arrangements for data processing. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A data processing circuit, the circuit comprising:
a sync mark pattern match calculation circuit operable to provide at least a first comparison value corresponding to a comparison between a received input data set and a sync mark pattern, and a second comparison value corresponding to a comparison between the received input data set and a subset of the sync mark pattern and a subset of a preamble pattern; and
an indication circuit operable to compare the first comparison value with the second comparison value, and to assert a sync found signal based at least in part on the comparison of the first comparison value and the second comparison value.

2. The circuit of claim 1, wherein the circuit is implemented as part of an integrated circuit.

3. The circuit of claim 1, wherein the circuit is implemented as part of a device selected from a group consisting of: a storage device and a wireless communication device.

4. The data processing circuit of claim 1, wherein the comparison between the received input data set and the sync mark pattern includes calculating a first Euclidean distance between the received input data set and the sync mark pattern; wherein the first comparison value is the first Euclidean distance; wherein the comparison between the received input data set and the received input data set and a subset of the sync mark pattern and a subset of a preamble pattern includes calculating a second Euclidean distance between the received input data set and the received input data set and a subset of the sync mark pattern and a subset of a preamble pattern; and wherein the second comparison value is the second Euclidean distance.

5. The data processing circuit of claim 1, wherein the sync mark pattern is M bits in length, wherein the subset of the sync mark pattern is N bits in length, and wherein the subset of the preamble pattern is M-N bits in length.

6. The data processing circuit of claim 5, wherein M is twenty, and wherein N is selected from a group consisting of: four, eight, twelve and sixteen.

7. The data processing circuit of claim 5, wherein the sync mark pattern match calculation circuit is operable to process Y bits at a time, and wherein the subset of the sync mark pattern is selected from a group consisting of: the 4Y most significant bits of the sync mark pattern, the 3Y most significant bits of the sync mark pattern, the 2Y most significant bits of the sync mark pattern, and the Y most significant bits of the sync mark pattern.

8. The data processing circuit of claim 5, wherein M is twenty, and wherein the subset of the sync mark pattern is selected from a group consisting of: the sixteen most significant bits of the sync mark pattern, the twelve most significant bits of the sync mark pattern, the eight most significant bits of the sync mark pattern, and the four most significant bits of the sync mark pattern.

9. The data processing circuit of claim 1, wherein the subset of the preamble pattern is a repeating portion of the preamble pattern.

10. The data processing circuit of claim 1, wherein the sync mark pattern is twenty bits in length, wherein the subset of the sync mark pattern is a first subset of the sync mark pattern, wherein the subset of the preamble pattern is a first subset of the preamble pattern, wherein the sync mark pattern match calculation circuit is further operable to:
provide a third comparison value corresponding to a comparison between the received input data set and a third subset of the sync mark pattern and a third subset of a preamble pattern;
provide a third comparison value corresponding to a comparison between the received input data set and a third subset of the sync mark pattern and a third subset of a preamble pattern;
provide a fourth comparison value corresponding to a comparison between the received input data set and a fourth subset of the sync mark pattern and a fourth subset of a preamble pattern; and
provide a fifth comparison value corresponding to a comparison between the received input data set and a fifth subset of the sync mark pattern and a fifth subset of a preamble pattern; and
wherein the indication circuit is further operable to compare the first comparison value with the second comparison value, the third comparison value, the fourth comparison value and the fifth comparison value, and to assert the sync found signal based at least in part on the comparison of the first comparison value, the second comparison value, the third comparison value, the fourth comparison value and the fifth comparison value.

11. The data processing circuit of claim 10, wherein the first subset of the preamble pattern, the second subset of the preamble pattern, the third subset of the preamble pattern, the fourth subset of the preamble pattern, and the fifth subset of the preamble pattern are the same.

12. The data processing circuit of claim 11, wherein the first subset of the preamble pattern, the second subset of the preamble pattern, the third subset of the preamble pattern, the fourth subset of the preamble pattern, and the fifth subset of the preamble pattern are the same repeating portion of the preamble pattern.

13. A method for detecting a data pattern, the method comprising:
receiving an input data set;
comparing the input data set with a first portion of a sync mark pattern to yield a first comparison value;
comparing the input data set with a second portion of the sync mark pattern to yield a second comparison value;
comparing the input data set with a preamble pattern to yield a third comparison value;
summing at least the first comparison value and the second comparison value to yield a first result;
summing at least the second comparison value and the third comparison value to yield a second result; and
asserting a sync found signal base upon the first result relative to the second result.

14. The method of claim 13, wherein comparing the input data set with the first portion of the sync mark pattern includes calculating a first Euclidean distance between the input data set and the first portion of the sync mark pattern; wherein the first comparison value is the first Euclidean distance; wherein comparing the input data set with the second portion of the sync mark pattern includes calculating a second Euclidean distance between the input data set and the second portion of the sync mark pattern; wherein the second comparison value is the second Euclidean distance; and wherein comparing the input data set with the preamble pattern includes calculating a third Euclidean distance between the input data set and the preamble pattern; wherein the third comparison value is the third Euclidean distance.

15. The method of claim 13, wherein the sync found signal indicates that a sync mark was found when at least the first result is less than the second result.

16. The method of claim 13, wherein the first portion of the sync mark pattern includes the most significant bits of the sync mark pattern, and wherein the second portion of the sync mark pattern includes the least significant bits of the sync mark pattern.

17. The method of claim 13, wherein the preamble pattern is a repeating portion of a larger pattern.

18. A data storage device, the storage device comprising:
a storage medium maintaining a representation of an input data set;
an analog front end circuit operable to sense the representation of the input data set and to provide the input data set as an output; and
a data processing circuit including:
a sync mark pattern match calculation circuit operable to provide at least a first comparison value corresponding to a comparison between a received input data set and a sync mark pattern, and a second comparison value corresponding to a comparison between the received input data set and a subset of the sync mark pattern and a subset of a preamble pattern; and
an indication circuit operable to compare the first comparison value with the second comparison value, and to assert a sync found signal based at least in part on the comparison of the first comparison value and the second comparison value.

19. The storage device of claim 18, wherein the comparison between the received input data set and the sync mark pattern includes calculating a first Euclidean distance between the received input data set and the sync mark pattern; wherein the first comparison value is the first Euclidean distance; wherein the comparison between the received input data set and the received input data set and a subset of the sync mark pattern and a subset of a preamble pattern includes calculating a second Euclidean distance between the received input data set and the received input data set and a subset of the sync mark pattern and a subset of a preamble pattern; and wherein the second comparison value is the second Euclidean distance.

20. The storage device of claim 18, wherein the sync mark pattern is twenty bits in length, wherein the subset of the sync mark pattern is a first subset of the sync mark pattern, wherein the subset of the preamble pattern is a first subset of the preamble pattern, wherein the sync mark pattern match calculation circuit is further operable to:
provide a third comparison value corresponding to a comparison between the received input data set and a third subset of the sync mark pattern and a third subset of a preamble pattern;
provide a third comparison value corresponding to a comparison between the received input data set and a third subset of the sync mark pattern and a third subset of a preamble pattern;
provide a fourth comparison value corresponding to a comparison between the received input data set and a fourth subset of the sync mark pattern and a fourth subset of a preamble pattern; and
provide a fifth comparison value corresponding to a comparison between the received input data set and a fifth subset of the sync mark pattern and a fifth subset of a preamble pattern; and
wherein the indication circuit is further operable to compare the first comparison value with the second comparison value, the third comparison value, the fourth comparison value and the fifth comparison value, and to assert the sync found signal based at least in part on the comparison of the first comparison value, the second comparison value, the third comparison value, the fourth comparison value and the fifth comparison value.
